(19) United States
(12) Patent Application Publication
(10) Pub. No.: US 2006/0149741 A1
(43) Pub. Date: Jul. 6, 2006

(54) Efficient Approach to Implement Applications on Server Systems in a Networked Environment

(75) Inventor: Karthick Krishnamoorthy, Chennai (IN)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: ORACLE INTERNATIONAL CORPORATION, Redwood Shores (US)

(21) Appl. No.: 10/905,431

(22) Filed: Jan. 4, 2005

(51) Int. Cl. G06F 17/30

(52) U.S. Cl. 707/10

(57) ABSTRACT

A central server which determines the specific server systems on which to execute (or terminate) an application type, and causes the application type to be executed on the determined server. Each application type may be implemented as objects permitting serialization. The central server may instantiate the objects to form corresponding processes, serialize the instantiated objects to generate corresponding byte stream, and transport the byte stream to the determined server system. The server system deserializes the byte stream and executes the objects to cause application instance to be available for processing requests. The processes are thus said to be transported to the server systems according such an example approach.

### BACKGROUND OF THE INVENTION

1. Field of the Invention

The present invention relates to networked environments, and more specifically to a method and apparatus for implementing applications on server systems in a networked environment.

2. Related Art

Applications are often implemented on server systems in a networked environment. In a typical configuration, the server systems are accessible using Internet Protocol (IP) on a network, and the applications are designed to communicate with other systems (using the underlying IP layer) to provide various features (such as processing HTTP requests which enable web browsing, transaction processing) to users.

In general, each application is executed on a corresponding server system. In one prior approach, each application is installed and configured for execution on one or more pre-specified server systems. A front end system may receive at least all the initial requests (e.g., HTTP requests) to access applications, and perform tasks such as load balancing in assigning the requests to specific one of the server systems (which are configured for processing of the corresponding request types).

One problem with such an approach is that each application may need to be installed on each of the assigned server systems, which may lead to unacceptably high overhead (e.g., for upgrades, etc.). In addition, the approach may not dynamically scale to distribute available processing resources to efficiently process potentially varying loads that may be received for each application type. For example, one application type may have heavy load in one time duration and another application type may have heavy load in another duration, and the approach may not provide more resources to applications presently servicing heavy loads.

Accordingly, what is needed is an efficient approach to implement applications on server systems in a networked environment which addresses one or more disadvantages noted above.

### BRIEF DESCRIPTION OF THE DRAWINGS

The present invention will be described with reference to the accompanying drawings briefly described below.

FIG. (FIG.) 1 is a block diagram of an example environment in which various aspects of the present invention can be implemented.

FIG. 2 is a flow chart illustrating the manner in which a central server may cause execution of various application types in corresponding server systems in an embodiment of the present invention.

FIG. 3 is a block diagram illustrating the details of an example central server implemented according to various aspects of the present invention.

FIG. 4 is a block diagram illustrating the details of an example server system implemented according to various aspects of the present invention.

FIG. 5 depicts the contents a status table using which a load balances distributes the requests to various server systems in an embodiment of the present invention.

FIG. 6 is a block diagram illustrating an example embodiment in which various aspects of the present invention are operative when software instructions are executed.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

1. Overview

A central server provided according to an aspect of the present invention determines the server systems on which each application type is to be executed, instantiates processes representing the application, and transports the processes to each determined server system. The server system uses the transported processes to execute the application type. Due to such an implementation, the code (executable modules containing software instructions) for each application type may not need to be implemented in each of the server systems (thereby reducing management overhead).

According to another aspect of the present invention, the central server communicates to a front-end server the server systems on which each application type is presently executing, and the front-end server then distributes requests of each type among the server systems which can process the requests of that type. Due to the availability of such a feature, the application instances may be additionally created (on other server systems) or terminated to dynamically adjust the processing resources available to meet the varying loads that each application type may need to process.

Various aspects of the present invention are described below with reference to an example problem. Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well_known structures or operations are not shown in detail to avoid obscuring the features of the invention.

2. Example Environment

FIG. 1 is a block diagram illustrating an example environment in which various aspects of the present invention can be implemented. The environment is shown containing client systems 110A-110N, network 120, front-end server 140, central server 150, intranet 170, and server systems 160A-160M. Each system is described below in further detail.

Network 120 provides the connectivity between client systems 110A-110N and front-end server 140, and may be implemented using protocols such as Internet Protocol (IP) in a known way. Similarly, intranet 170 provides connectivity between front-end server 140 and server systems 160A-160M.

Server systems 160A-160M execute various application instances (of different types), with each application instance processing corresponding requests. As described in sections below, server systems 160A-160M are all designed to cooperatively operate with front-end server 140 to cause execution of applications (instances).

For illustration, it is assumed that client systems 110A-110N send requests directed to applications executing on server systems 160A-160M. However, the requests can be generated by other types of systems as well. The requests are further assumed to be with a destination address of front-end server 140, with further content of the requests (IP packets) specifying the application to which the request is directed (and other related information).

Front-end server 140 processes the requests received on network 120 to one of server systems 160A-160M, and forwards corresponding responses received from the server system to network 120. Each request is forwarded to one of the server systems executing an application type which can process the request, and the corresponding information may be provided by central server 150 as described in sections below.

Central server 150 determines the specific one of server systems 160A-160M on which to execute each application type, and causes the application type to be executed on the corresponding server systems. The manner in which central server 150 provides various features of the present invention is described below in further detail.

3. Flow-Chart

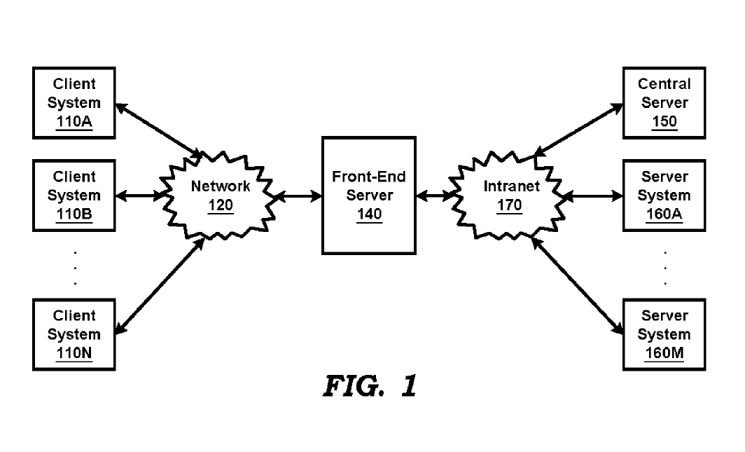

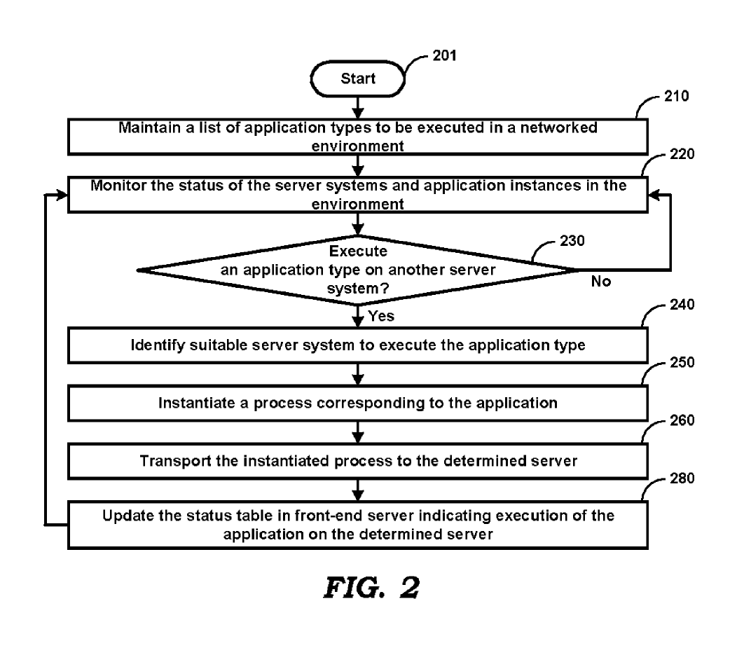

FIG. 2 is a flow-chart illustrating the manner in which a central server may operate according to an aspect of the present invention. The flow chart is described with reference to FIG. 1 merely for illustration. However, the features can be implemented in other environments/systems as well. The flow chart begins in step 201, in which control immediately passes to step 210.

In step 210, central server 150 maintains a list of application types to be executed in a networked environment. For example, one application type could process all HTTP requests, and another application type could process database requests.

In step 220, central server 150 monitors the status of the servers and application instances in the environment. For example, the present load and idle time in each server system, whether the application instance is active or already terminated (e.g., due to memory outage in the server system), may be monitored.

In step 230, central server 150 determines whether to execute an application type on a server system. An application type may be executed on a server system, for example, if no other server system is executing the application type or if additional processing capacity is required to process the present/expected load for the corresponding request types. Control passes to step 240 if it is determined to execute an application type on a server system and to step 230 otherwise.

In step 240, central server 150 identifies a suitable server system to execute the application type. The server system may be selected based on factors such as idle time in the past short duration (e.g., 10 minutes), the processing capacity (e.g., measured in MIPS), any specialized needs for the application type (e.g., access required to a database).

In step 250, central server 150 instantiates a process representing the application, and in step 260 transports the instantiated process to the determined server. The determined server initiates an application instance from the received data stream. An example approach to performing steps 250 and 260 is described below in further detail.

In step 280, central server 150 updates the status tables in front-end server 140 indicating execution of the application on the determined server. Control then passes to step 220.

It may be appreciated that the loop of steps 220 through 280 may implemented for each application type and sufficient number of instances of the application type may be created. In addition, each server system may be designed to execute any of the application types, and central server 150 may dynamically assign applications to desired server systems. Accordingly, it may be desirable that each application is implemented using languages (or other supporting systems) which allow dynamic transportability of applications across all server systems during run-time.

Server systems 160A-160M and central server 150 may be implemented several ways using the approaches described below. Some example implementations are described below in further detail.

4. Central Server

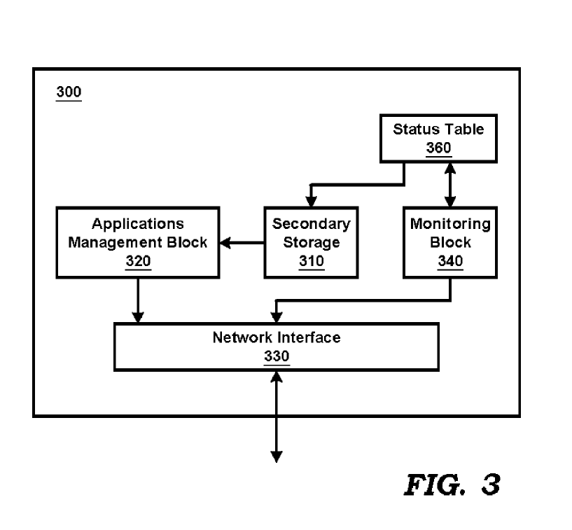

FIG. 3 is a block diagram illustrating the details of central server 150 in an embodiment. Central server 150 is shown containing secondary storage 310, applications management block 320, monitoring block 340, network interface 330 and status tables 360. Each component is described below in further detail.

Network interface 330 provides the physical, electrical and protocol (IP/TCP) interfaces necessary for various blocks in central server 150 to communicate with other systems. Monitoring block 340 monitors the status of various server systems and the applications executing thereon. The results of monitoring are stored in status tables 360.

The status tables may contain various types of information used in determining whether to execute an application type on another server system or to terminate a presently executing application instance. Monitoring block 340 makes available (or stores in) the information necessary for front-end server 140 to route each request to one of the server systems executing an application type with the ability to process the request.

Secondary storage 310 stores the application code which can be executed to instantiate processes corresponding to each application type. Applications management block 320 interfaces with individual server systems to execute or terminate various application instances. Decisions on whether to execute or terminate the application instances can be based on various factors noted above. Once a decision is made, the manner in which application instances can be executed or terminated will be clearer from the description below.

5. Server Systems

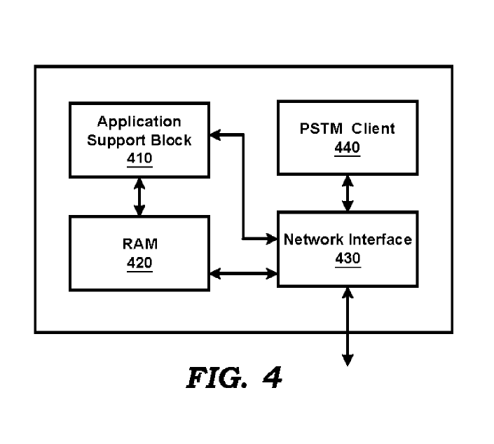

FIG. 4 is a block diagram illustrating the details of server system 160A in one embodiment. Even though the description is provided with respect to server system 160A for illustration, the description is applicable to other server systems as well. Server system 160A is shown containing application support block 410, random access memory (RAM) 420 and network interface 430. Each block is described below in further detail.

Network interface 430 also provides the physical, electrical and protocol (IP/TCP) interfaces necessary for various blocks in server system 160A to communicate with other systems. RAM 420 provides the support for execution of various application instances as well as other blocks of server system 160A.

Application support block 410 processes various commands received from central server 150. Some of the commands may require status information (e.g., which application instances are presently executing, the idle time, number of requests processed), and application support block 410 examines the internal status in server system 160A, and generates the corresponding responses.

Some of the other commands may correspond to executing application instances or terminating presently executing application instances. Application support block 410 accordingly needs to be provided the necessary privileges (often referred to as Super User Privileges) to initiate or terminate the application instances. The commands can be received using any cooperating protocol/interface consistent with the interface of application management block 320.

In one embodiment, central server 150 is provided ‘super user’ privileges to enable the termination and execution of application instances (as well as for monitoring) and the commands are received according to Simple Object Access Protocol (SOAP) well known in the relevant arts. In general, SOAP permits extensions for definition of new packet formats, which can be used to implement higher level protocols. A type field can be used to specify the type (e.g., monitor request, transporting a process, termination of an application instance), and further fields can be defined to provide the additional information necessary to provided for each SOAP command.

The termination of an application instance generally depends on the implementation of the operating system executing on the server system, and the termination can be performed in a known way. The description is continued with respect to the manner in which central server 150 can cause application types to be executed on server systems.

6. Executing Applications On Server Systems

In general, application management block 320 and application support block 410 need to be implemented in a cooperative manner to enable central server 150 to cause execution of a desired application type on server system 160A. As noted in steps 250 an 260 above, in one embodiment processes representing the application are instantiated, and then each process is transported to server system 160A. The server system again instantiates the processes to obtain the application instance.

In one embodiment in which the software code for each application type is available according to Java programming language, each application type is designed in the form of one or more objects which expressly permit serialization. In such a scenario, application management block 320 can instantiate each of the objects thereby forming processes. Each object is then serialized to generate the corresponding byte stream.

The byte stream is then transported using network interfaces 330 and 430 to application support block 410, which deserializes the byte stream and executes the objects to obtain the processes (and thus the application instance) on server system 160A. Serialization and deserialization are described in further detail in a book entitled, “The complete Reference Java™2—Fifth Edition”, by Herbert Schildt, ISBN 0-07-049543-2. The serialized data can be sent according to a convention defined consistent with the SOAP protocol, noted above. Application support block 410 and application management block 320 need to be designed consistent with the convention.

Once the application instance is thus present on server system 160A, the corresponding information is provided to front-end server 140 such that the load of processing specific request types can be distributed among the server systems executing the application type which can process the requests. In an embodiment, front-end server 140 maintains the information in a status table, the contents of which are described below.

7. Status Table in Front-end Server

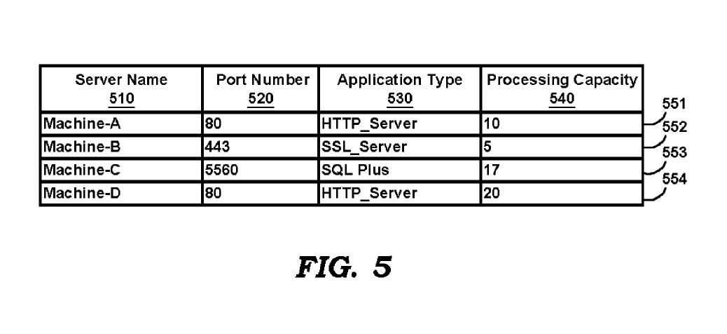

FIG. 5 illustrates the contents of a status table maintained in front-end server 140 in one embodiment. The table is used by front-end server 140 to route each request to corresponding server system. It may be further appreciated that server system 160A may also maintain some of the information in status table 360 and use the information in determining the server on which to execute each application type.

Continuing with respect to FIG. 5, as shown there, the status table contains four columns server name 510, port number 520, application type 530, and processing capacity 540. Each column is described below in further detail with reference to rows 551-554.

Rows 551 and 554 indicate that HTTP server application type (column 530) is available on server systems having names Machine-A and Machine-D respectively. The application type may be determined by a matching port number 80, as shown. The processing capacity of machines A and D are respectively indicated as 10 and 20 respectively, indicating that machine D can be assigned twice as many requests as machine A.

Similarly, rows 552 and 553 respectively indicate that machines B and C are presently executing application types SSL-server (secure socket layer) and SQL plus¹. Accordingly, requests related to SSL and database queries may be forwarded to machines B and C respectively.

Thus, central server 150 can dynamically initiate or terminate application instances, and update the status table of FIG. 5 to reflect the corresponding status. Front-end server 140 can then use the table to distribute the requests among various servers capable of executing the application type.

8. Digital Processing System

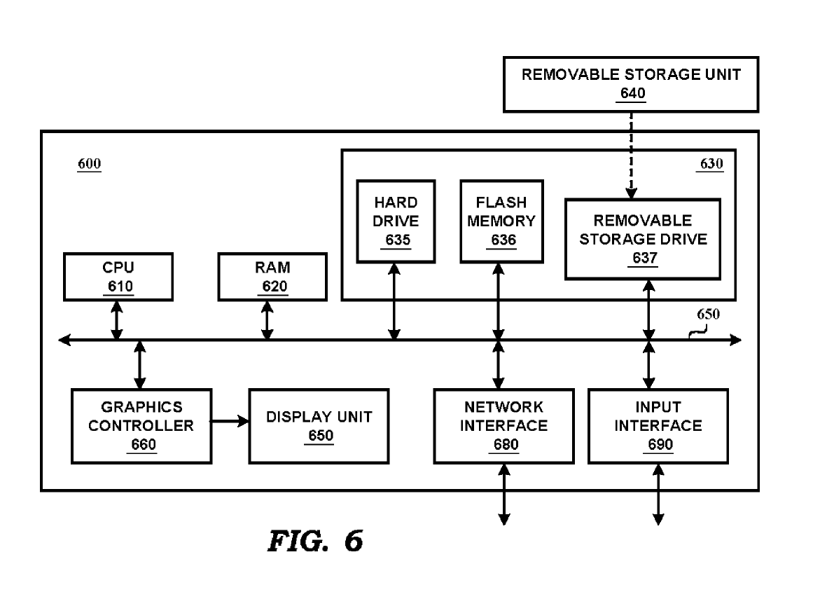

FIG. 6 is a block diagram illustrating the details of digital processing system 600 in which various aspects of the present invention are operative by execution of appropriate software instructions. System 600 may correspond to central server 150 or server system 160A. System 600 may contain one or more processors such as central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single general purpose processing unit. RAM 620 may receive instructions from secondary memory 630 using communication path 650.

Graphics controller 660 generates display signals (e.g., in RGB format) to display unit 670 based on data/instructions received from CPU 610. Display unit 670 contains a display screen to display the images defined by the display signals. Input interface 690 may correspond to a key_board and/or mouse. Network interface 680 provides connectivity to a network (e.g., using Internet Protocol), and may be used to receive various service requests and to provide the corresponding responses.

Secondary memory 630 may contain hard drive 635, flash memory 636 and removable storage drive 637. Secondary memory 630 may store the data and software instructions (e.g., methods instantiated by each of client system), which enable system 600 to provide several features in accordance with the present invention. Some or all of the data and instructions may be provided on removable storage unit 640, and the data and instructions may be read and provided by removable storage drive 637 to CPU 610. Floppy drive, magnetic tape drive, CD_ROM drive, DVD Drive, Flash memory, removable memory chip (PCMCIA Card, EPROM) are examples of such removable storage drive 637.

Removable storage unit 640 may be implemented using medium and storage format

compatible with removable storage drive 637 such that removable storage drive 637 can read

the data and instructions. Thus, removable storage unit 640 includes a computer readable storage medium having stored therein computer software and/or data.

In this document, the term “computer program product” is used to generally refer to removable storage unit 640 or hard disk installed in hard drive 635. These computer program products are means for providing software to system 600. CPU 610 may retrieve the software instructions, and execute the instructions to provide various features of the present invention described above.

### CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A network system processing a plurality of requests from a plurality of client systems, said network system comprising:
a plurality of server systems;
a central server determining a suitable server for executing a first application type, said suitable server being contained in said plurality of server systems, said central server executing said first application type on said suitable server; and
a front-end server receiving information indicating that said first application type is executing on said suitable server, said front-end server forwarding requests which can be processed by said first application type to said suitable server.

2. The network system of claim 1, wherein said central server determines a second suitable server for executing said first application type, said second suitable server also being contained in said plurality of server systems,
said front-end server distributing a first set of requests between said second suitable server and said first suitable server, wherein each of said first set of requests can be processed by said first application type and said first set of requests are contained in said plurality of requests.

3. The network system of claim 2, wherein said central server instantiates a plurality of processes representing said first application type, and causes said plurality of processes to be transported to each of said suitable server and said second suitable server, whereby each of said plurality of servers need not store code corresponding to said first application type.

4. The network system of claim 3, wherein an application code corresponding to said application type contains a plurality of objects which can be serialized to corresponding data sequences,
said central server instantiating each of said plurality of objects to form said corresponding processes and serializing each instantiated process to generate a corresponding data sequence, each of said suitable server and said second suitable server receiving said data sequences and forming said plurality of processes to obtain a corresponding instance of said application type.

5. The network system of claim 4, wherein each of said plurality of objects comprises a Java object.

6. A method performed in a central server to implement applications on a plurality of server systems contained in a networked environment, said method comprising:
maintain a list of application types to be executed in said networked environments;
determining a suitable server for executing a first application type, said suitable server being contained in said plurality of server systems; and
initiating execution of said first application type on said suitable server.

7. The method of claim 6, wherein said initiating comprises:
instantiating a plurality of processes representing said first application type; and
transporting said plurality of processes to said suitable server.

8. The method of claim 7, wherein a code representing said first application type comprises a plurality of objects, wherein each of said plurality of objects can be serialized, said method further comprising:
serializing said plurality of objects to form a corresponding plurality of data sequences; and
forwarding said corresponding plurality of data sequences to said suitable server,
wherein said suitable server deserializes said plurality of data sequences and obtains an application instance based on said plurality of data sequences.

9. The method of claim 8, wherein each of said plurality of objects is written according to Java language.

10. The method of claim 7, further comprising sending a command to said suitable server, wherein said command requests that an application instance corresponding to said first application type on said suitable server be terminated, wherein said suitable server terminates said application request upon receiving said command.

11. The method of claim 10, further comprising monitoring a status of said application instance by sending appropriate commands and receiving corresponding responses.

12. A computer readable medium carrying one or more sequences of instructions causing a central server to implement applications on a plurality of server systems contained in a networked environment, wherein execution of said one or more sequences of instructions by one or more processors contained in said central server causes said one or more processors to perform the actions of:
maintain a list of application types to be executed in said networked environments;
determining a suitable server for executing a first application type, said suitable server being contained in said plurality of server systems; and
initiating execution of said first application type on said suitable server.

13. The computer readable medium of claim 12, wherein said initiating comprises:
instantiating a plurality of processes representing said first application type; and
transporting said plurality of processes to said suitable server.

14. The computer readable medium of claim 13, wherein a code representing said first application type comprises a plurality of objects, wherein each of said plurality of objects can be serialized, further comprising:
serializing said plurality of objects to form a corresponding plurality of data sequences; and
forwarding said corresponding plurality of data sequences to said suitable server,
wherein said suitable server deserializes said plurality of data sequences and obtains an application instance based on said plurality of data sequences.

15. The computer readable medium of claim 14, wherein each of said plurality of objects is written according to Java language.

16. The computer readable medium of claim 13, further comprising sending a command to said suitable server, wherein said command requests that an application instance corresponding to said first application type on said suitable server be terminated, wherein said suitable server terminates said application request upon receiving said command.

17. The computer readable medium of claim 16, further comprising monitoring a status of said application instance by sending appropriate commands and receiving corresponding responses.
